(19) United States
(12) Patent Application Publication
(10) Pub. No.: US 2003/0077082 A1
(43) Pub. Date: Apr. 24, 2003

(54) Pan/tilt camera system

(75) Inventor: Tomokazu Ito, Toyoake (JP)

Correspondence Address: Koda & Androlia, Suite 3850, 2029 Century Park East, Los Angeles, CA, 90067, US

(73) Assignee: Elmo Co., Ltd.

(21) Appl. No.: 10/234,602

(22) Filed: Sep. 4, 2002

(30) Foreign Application Priority Data
Oct. 22, 2001 (JP) 2001-323907

(51) Int. Cl. G03B 17/00

(52) U.S. Cl. 396/428

(57) ABSTRACT

A pan/tilt camera system includes a sensor spaced from a rotational shaft of a pan/tilt camera, a detected piece rotated with the rotational shaft so as to correspond to the sensor, an origin setting unit rotating the rotational shaft in a first direction upon turn-on of a power so that the detected piece corresponds to the sensor and thereafter, rotating the rotational shaft in a second direction opposite to the first direction so that the sensor detects a rear end of the detected piece with respect to the rotation direction of the detected piece, setting an origin, a pulse counter applying a predetermined number of pulses to the motor after set of the origin so that the rotational shaft is continuously rotated in the second direction and further so that the rotational shaft is subsequently reversed at a speed equal to the predetermined speed, the pulse counter counting pulses applied to the motor until a front end of the detected piece with respect to the rotation direction of the detected piece is detected, and a backlash calculating unit comparing a count of the pulse counter with the predetermined number of pulses applied to the motor thereby to calculate an amount of backlash of the drive mechanism. Position control of the pan/tilt camera is compensated for on the basis of the amount of backlash calculated by the backlash calculating unit.

### BACKGROUND OF THE INVENTION

1. Field of the Invention

This invention relates generally to apan/tilt camera system, and more particularly to position control for a pan/tilt camera employed in such a system.

2. Description of the Related Art

A stepping motor has conventionally been used for position control of a pan/tilt camera in pan and tilt directions. Since the stepping motor is rotated according to the number of pulses applied thereto, a precise position control can be carried out. However, rotation of the stepping motor is transmitted through a drive mechanism such as a transmission or reduction mechanism, to each of rotational shafts for pan and tilt directions. Accordingly, an amount of backlash of each drive mechanism varies depending upon an external factor such as temperature or humidity or depending upon aged deterioration, whereupon a high-precision position control cannot be carried out.

### SUMMARY OF THE INVENTION

Therefore, an object of the present invention is to provide a pan/tilt camera system in which an amount of backlash of the drive mechanism is calculated every time the power is turned on and position control of the pan/tilt camera is compensated for on the basis of the obtained amount of backlash, whereupon a high-precision position control can be carried out.

The present invention provides apan/tilt camera system which includes a pan/tilt camera driven by a drive mechanism including a stepping motor and having a rotational shaft, a control circuit for controlling the pan/tilt camera and a monitor for displaying an image photographed by the pan/tilt camera. The system comprises a sensor spaced from the rotational shaft of the pan/tilt camera, and a detected piece rotated with the rotational shaft so as to correspond to the sensor. An origin setting unit is provided for rotating the rotational shaft in a first direction upon turn-on of a power so that the detected piece corresponds to the sensor. Thereafter, the origin setting unit rotates the rotational shaft in a second direction opposite to the first direction so that the sensor detects a rear end of the detected piece with respect to the rotation direction of the detected piece, thereby setting an origin. A pulse counter is provided for applying a predetermined number of pulses to the motor after set of the origin so that the rotational shaft is continuously rotated in the second direction and further so that the rotational shaft is subsequently reversed at a speed equal to the predetermined speed. The pulse counter counts pulses applied to the motor until a front end of the detected piece with respect to the rotation direction of the detected piece is detected. A backlash calculating unit is provided for comparing a count of the pulse counter with the predetermined number of pulses applied to the motor thereby to calculate an amount of backlash of the drive mechanism. In this construction, position control of the pan/tilt camera is compensated for on the basis of the amount of backlash calculated by the backlash calculating unit.

In the above-described system, the rotational shaft is rotated upon turn-on of the power so that the detected piece corresponds to the sensor. Thereafter, the shaft is rotated in the opposite direction so that the sensor detects the rear end of the detected piece with respect to the rotation direction, whereby the origin is set. The predetermined number of pulses is applied to the motor so that the shaft is continuously rotated reverse at the predetermined speed. Thereafter, the shaft is returned at the same speed as the predetermined speed, and the pulses are counted until the front end of the detected piece with respect to the return direction is detected by the sensor. The count of the pulse counter is compared with the predetermined number of pulses applied to the motor, so that the amount of backlash of the drive mechanism is calculated. Position control of the pan/tilt camera is compensated for on the basis of the calculated amount of backlash. Thus, an amount of backlash of the drive mechanism is calculated every time the power is turned on. Position control of the pan/tilt camera is compensated for on the basis of the obtained amount of backlash. Consequently, even when the amount of backlash of the drive mechanism varies depending upon an external factor such as temperature or humidity or depending upon aged deterioration, a high-precision position control can usually be carried out.

In a preferred form, the drive mechanism includes a worm gear transmitting a driving force developed by the stepping motor, two synchronous pulleys fitted on an output shaft and a worm shaft of the stepping motor respectively, and a synchronous toothed belt extending between the synchronous pulleys. Consequently, the transmission and reduction mechanism cam smoothly be driven.

In another preferred form, the sensor comprises a photosensor. Consequently, the detected piece can be detected at a high speed with high precision.

### BRIEF DESCRIPTION OF THE DRAWINGS

Other objects, features and advantages of the present invention will become clear upon reviewing the following detailed description of the invention, made with reference to the accompanying drawings, in which:

FIG. 1 is a schematic diagram showing one embodiment of a pan/tilt camera system in accordance with the present invention;

FIG. 2 is a front view of a pan/tilt camera of the system;

FIG. 3 is a side view of the pan/tilt camera; and

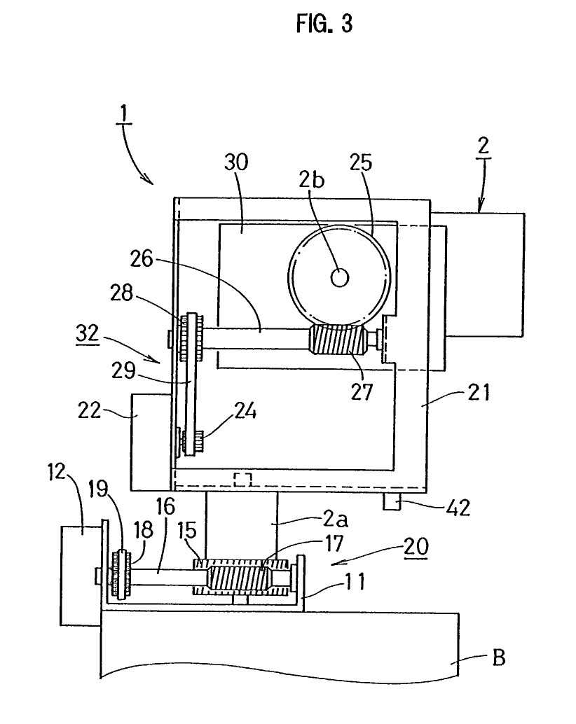

FIG. 4 is a flowchart showing a backlash calculating process carried out by a drive mechanism.

### DETAILED DESCRIPTION OF THE INVENTION

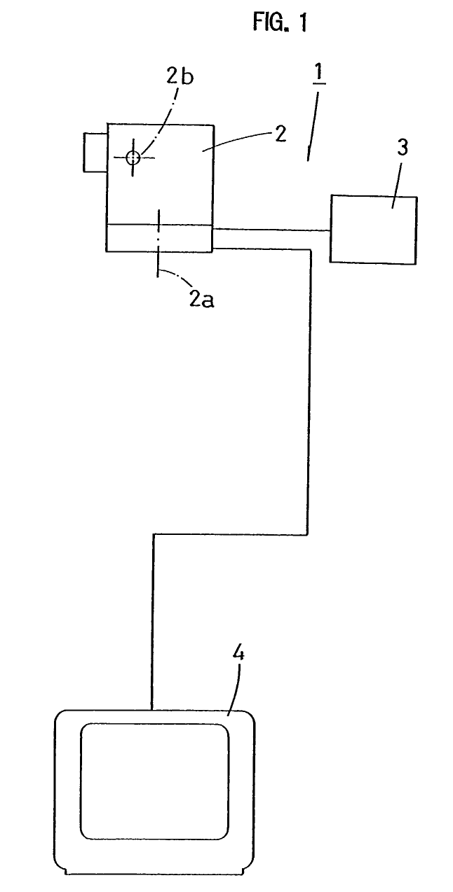

One embodiment of the pan/tilt camera system in accordance with the invention will be described with reference to the accompanying drawings. Referring to FIG. 1, a schematic arrangement of a pan/tilt camera system 1 is shown. The pan/tilt camera system 1 comprises a pan/tilt camera 2, a control circuit 3 for controlling the pan/tilt camera, and a monitor 4 for displaying an image photographed by the pan/tilt camera. The control circuit 3 delivers drive pulses on the basis of control software installed therein in order to control the operation of the pan/tilt camera 2. The pan/tilt camera 2 includes a rotational shaft 2a for a pan direction and a rotational shaft 2b for a tilt direction. Each of the shafts 2a and 2b is driven by a drive mechanism including a stepping motor so as to be rotated by a predetermined angle, as will be described in detail later.

The pan/tilt camera 2 further includes a base B on which a motor bracket 11 is mounted. The stepping motor 12 is mounted on the motor bracket 11. The motor 12 has an output shaft 13 on which a synchronous pulley 14 is fitted. The pan shaft 2a is rotatably mounted on the motor bracket 11. A worm wheel 15 is fitted on the shaft 2a, and a worm shaft 16 is rotatably mounted on the motor bracket 11. The worm shaft 16 has a worm 17 which is in mesh engagement with the worm wheel 15. A synchronous pulley 18 having a larger diameter than the synchronous pulley 14 is fitted on the worm shaft 16. A synchronous toothed belt 19 extends between the synchronous pulleys 14 and 18. Thus, a drive mechanism 20 for the pan direction is constructed to reduce and transmit a driving force developed by the motor 12.

The pan shaft 2a has an upper end fixed to a turning bracket 21. Another stepping motor 22 is mounted on the turning bracket 21. The motor 22 has an output shaft 23 on which a synchronous pulley 24 is fitted. The tilt shaft 2b is rotatably mounted on the turning bracket 21. A worm wheel 25 is fitted on the shaft 2b, and a worm shaft 26 is rotatably mounted on the turning bracket 21. The worm shaft 26 has a worm 27 which is in mesh engagement with the worm wheel 25. A synchronous pulley 28 having a larger diameter than the synchronous pulley 24 is fitted on the worm shaft 26. A synchronous toothed belt 29 extends between the synchronous pulleys 24 and 28. The shaft 2b has a distal end to which a camera holder 30 is fixed. A camera body 31 of the pan/tilt camera 2 is mounted on the camera holder 30. Thus, a drive mechanism 32 for the tilt direction is constructed to reduce and transmit a driving force of the motor 22.

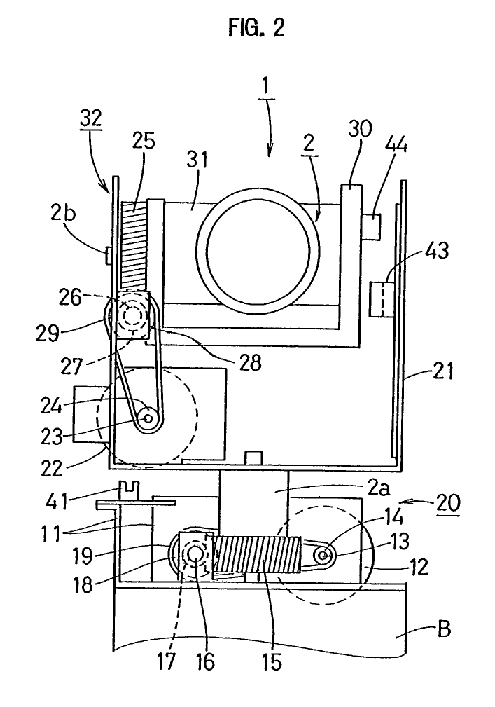

A photosensor 41 is mounted on an upper face of the motor bracket 11 so as to be spaced from the shaft 2a or so as to confront a left-hand end of the underside of the turning bracket 21, as viewed in FIG. 2. A detected piece 42 is mounted on the underside of the turning bracket 21 so as to correspond to the photosensor 41. Another photosensor 43 is mounted on an inner surface of the turning bracket 21 so as to confront a left-hand portion of the underside of the camera holder 30, as viewed in FIG. 2. A detected piece 44 is mounted on the under side of the turning bracket 21 so as to correspond to the photosensor 43. An on-off signal generated by each of the photosensors 41 and 43 is supplied to the control circuit 3.

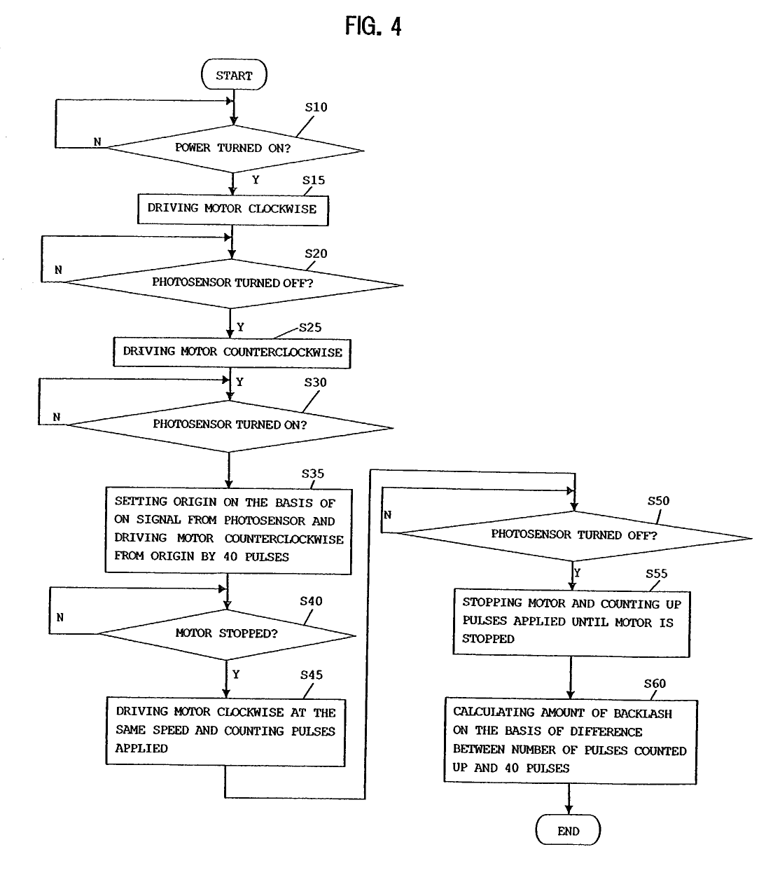

Referring now to FIG. 4, a backlash calculating process for the pan direction drive mechanism 20 is schematically shown. The backlash calculating process is carried out by the control circuit 3. When determining at step S10 that the power has been turned on, the control circuit 3 advances to step S15 to rotate the motor 12 clockwise. As the result of the clockwise rotation of the motor 12, the detected piece 42 intercepts light emitted by the photosensor 41. When determining at step S20 that the photosensor 41 has been turned off, the control circuit 3 advances to step S25 to stop the motor 12 and then to rotate it counterclockwise.

As the result of reverse rotation of the shaft 2a, the rear end of the detected piece 42 with respect to the rotation direction passes the photosensor 41, whereupon the photosensor is turned on. When determining at step S30 that the photosensor 41 has been turned on, the control circuit 3 advances to step S35 to set an origin based on the on-signal of the photosensor. Furthermore, a predetermined number of pulses, for example, 40 pulses are applied to the motor 12 so that the motor assuming the origin is rotated counterclockwise at a predetermined speed by an amount corresponding to the number of applied pulses. Furthermore, the control circuit 3 advances to step S40. When determining at step S40 that the motor 12 has been stopped, the control circuit 3 advances to step S45 to rotate the motor 12 clockwise at a speed equal to that in the counterclockwise rotation, whereupon the shaft 2a is returned. The control circuit 3 also starts counting the pulses applied to the motor 12.

As the result of the return of the motor 12, the front end of the detected piece 42 intercepts light emitted by the photosensor 41. When determining at step S50 that the photosensor 41 has been turned off, the control circuit 3 advances to step S55 to stop the motor 12 and then to count up pulses applied to the motor until it is stopped. The control circuit 3 further advances to step S35 to obtain the difference between the number of pulses counted up and the number of applied pulses (40 pulses), calculating an amount of backlash.

The drive mechanism 32 for the tilt direction has substantially the same construction as the above-described drive mechanism 20 for the pan direction. The backlash calculating process is carried out by the drive mechanism 32 in the same manner as described above and accordingly, a detailed description of the backlash calculating process carried out by the drive mechanism 32 is eliminated.

In the above-described pan/tilt camera system 1, an amount of backlash of each drive mechanism 20 or 32 is calculated every time the power is turned on. Position control of the pan/tilt camera 2 in the pan and tilt directions is compensated for on the basis of the obtained amounts of backlash. Consequently, even when the amount of backlash of each drive mechanism varies depending upon an external factor such as temperature or humidity or depending upon aged deterioration, a high-precision position control can usually be carried out.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A pan/tilt camera system which includes a pan/tilt camera driven by a drive mechanism including a stepping motor and having a rotational shaft, a control circuit for controlling the pan/tilt camera and a monitor for displaying an image photographed by the pan/tilt camera, the system comprising:
a sensor spaced from the rotational shaft of the pan/tilt camera;
a detected piece rotated with the rotational shaft so as to correspond to the sensor;
an origin setting unit rotating the rotational shaft in a first direction upon turn-on of a power so that the detected piece corresponds to the sensor and thereafter, rotating the rotational shaft in a second direction opposite to the first direction so that the sensor detects a rear end of the detected piece with respect to the rotation direction of the detected piece, thereby setting an origin;
a pulse counter applying a predetermined number of pulses to the motor after set of the origin so that the rotational shaft is continuously rotated in the second direction and further so that the rotational shaft is subsequently reversed at a speed equal to the predetermined speed, the pulse counter counting pulses applied to the motor until a front end of the detected piece with respect to the rotation direction of the detected piece is detected;
a backlash calculating unit comparing a count of the pulse counter with the predetermined number of pulses applied to the motor thereby to calculate an amount of backlash of the drive mechanism, wherein position control of the pan/tilt camera is compensated for on the basis of the amount of backlash calculated by the backlash calculating unit.

2. A pan/tilt camera system according to claim 1, wherein the drive mechanism includes a worm gear transmitting a driving force developed by the stepping motor, two synchronous pulleys fitted on an output shaft and a worm shaft of the stepping motor respectively, and a synchronous toothed belt extending between the synchronous pulleys.

3. A pan/tilt camera system according to claim 1, wherein the sensor comprises a photosensor.

4. A pan/tilt camera system according to claim 2, wherein the sensor comprises a photosensor.
